(19) United States
(12) Patent Application Publication
(10) Pub. No.: US 2014/0372806 A1
(43) Pub. Date: Dec. 18, 2014

(54) VIRTUAL MACHINE SYSTEM AND INFORMATION STORING PROCESSING METHOD

(71) Applicant: FUJITSU LIMITED, Kawasaki-shi (JP)

(72) Inventors: Masakazu Yabe, Setagaya (JP); YUSUKE KUDOU, Kawasaki (JP)

(21) Appl. No.: 14/470,238

(22) Filed: Aug. 27, 2014

Related U.S. Application Data
(63) Continuation of application No. PCT/JP2012/056482, filed on Mar. 13, 2012.

(51) Int. Cl. G06F 11/07; G06F 9/455; G06F 11/30

(52) U.S. Cl. CPC G06F 11/0778; G06F 11/301; G06F 9/45533
USPC 714/38.11

(57) ABSTRACT

A virtual machine system includes a first storage unit, a second storage unit, and a processor. The first storage unit includes a storage area allocated for a first virtual machine to operate. The second storage unit stores information stored in the first storage unit. The processor executes a process including detecting a failure of a first virtual machine, generating a second virtual machine when a failure of the first virtual machine is detected and making the second virtual machine perform storing information stored in the first storage unit into the second storage unit, and deleting the second virtual machine when the storing by the second virtual machine is completed.

### CROSS-REFERENCE TO RELATED APPLICATIONS

This application is a continuation application of International Application PCT/JP2012/056482 filed on Mar. 13, 2012 and designated the U.S., the entire contents of which are incorporated herein by reference.

### FIELD

The embodiments discussed herein are related to a technique for a virtual machine.

### BACKGROUND

When abnormality occurs in a system, information about the CPU (Central Processing Unit) and the memory at the time of the occurrence of the abnormality is used to investigate its cause. This information is stored as a dump file in an auxiliary storage apparatus, to be used for subsequent investigation for the cause. When abnormality occurs, the system performs a restart and resumes task processing after creating a dump file.

When a restart is performed through a system reset at the time of occurrence of abnormality, the content of the memory at the time of the occurrence of the failure is destroyed by the initialization of the memory controller, the memory check on the BIOS (Basic Input/Output System), and the initialization process for the OS (Operating System). In order to protect the content of the memory from such destruction, a memory dump is performed before a system reset.

The processing time for a memory dump targeted at all of the areas of the memory is proportional to the capacity of the memory. Along with the increase in the memory capacity of systems year after year, the task suspension time tends to be extended as well.

FIG. 1 illustrates an example of the flow of a dump process, indicating the relationship between the dump process and the task suspension time. In FIG. 1, when a failure occurs during task operation (S101), the server is restarted by an INIT interruption (S102), and a memory dump is performed (S103). After the completion of the dump, a system reset is issued (S104), the system is restarted (S105), and the operation shifts to the normal operation (S106). In recent years, the dump process takes several tens of minutes to several hours, causing tasks to be suspended for a long time.

Meanwhile, techniques described in documents such as, for example, Japanese Laid-open Patent Publication 2005-122334 have been known.

### SUMMARY

According to an aspect of the embodiment, a virtual machine system includes a first storage unit, a second storage unit, and a processor. The first storage unit includes a storage area allocated for a first virtual machine to operate. The second storage unit stores information stored in the first storage unit. The processor executes a process including detecting a failure of a first virtual machine, generating a second virtual machine when a failure of the first virtual machine is detected and making the second virtual machine perform storing information stored in the first storage unit into the second storage unit, and deleting the second virtual machine when the storing by the second virtual machine is completed.

The object and advantages of the invention will be realized and attained by means of the elements and combinations particularly pointed out in the claims.

It is to be understood that both the foregoing general description and the following detailed description are exemplary and explanatory and are restrictive of the invention.

### BRIEF DESCRIPTION OF DRAWINGS

FIG. 1 illustrates the relationship between a dump process and the task suspension time in a system;

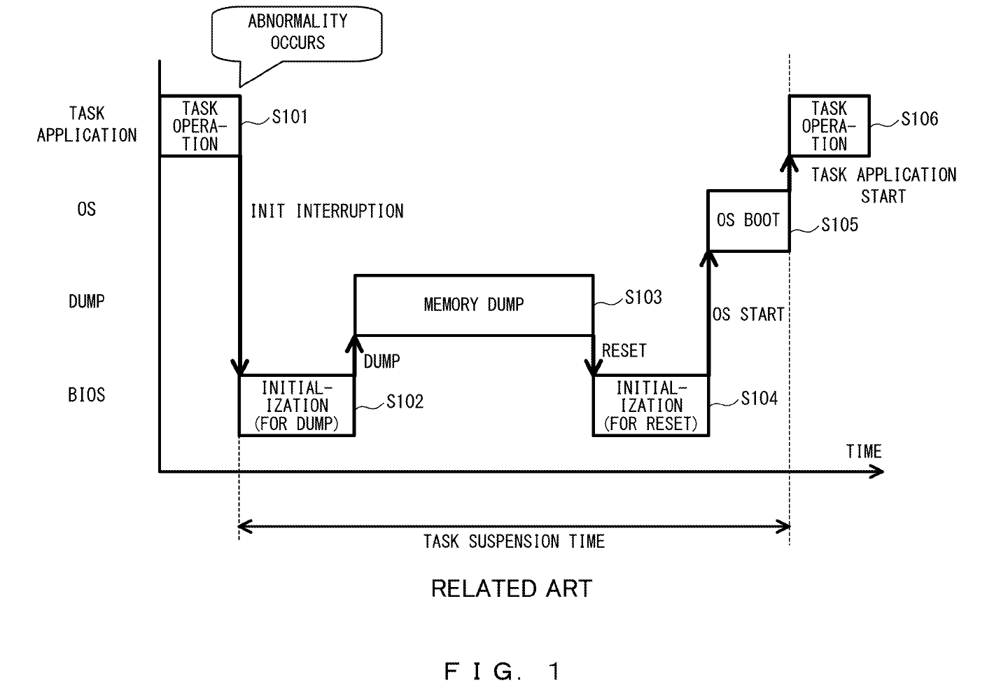

FIG. 2 illustrates the configuration of a virtual machine system according to the embodiment;

FIG. 3 illustrates the configuration of a virtual machine system according to a first embodiment;

FIG. 4 illustrates an example of the configuration of a page table;

FIGS. 5A, 5B, and 5C are diagrams for explaining memory allocation in a dump process;

FIG. 6 illustrates the flow of a memory dump process according to the first embodiment;

FIG. 7 illustrates the configuration of a virtual machine system according to a second embodiment;

FIG. 8 illustrates the configuration of an unused area pool according to the second embodiment;

FIG. 9 illustrates the flow of a memory dump process according to the second embodiment;

FIG. 10 is a diagram for explaining the division of the address space of a task VM according to a third embodiment into an OS boot area and a hot-add area;

FIG. 11 illustrates the configuration of a virtual machine system according to the third embodiment; and

FIG. 12 illustrates the flow of a memory dump process according to the third embodiment.

### DESCRIPTION OF EMBODIMENTS

As a method for shortening the dump time, there is a method in which, when a failure occurs in a computer, a dump process is started simultaneously with the resumption of task processing, and the dump process is performed in parallel with the task processing. This method involves a virtual machine for memory dump that is constantly on standby, in addition to the virtual machine that executes tasks. When abnormality occurs in the virtual machine for tasks, the virtual machine for memory dump performs a dump, while the virtual machine for tasks reboots in parallel with it.

However, the method mentioned above is poor in efficiency because a virtual machine for the dump process is provided permanently to stand by for the dump process, which needs an additional resource corresponding to one virtual machine.

In a virtual machine system in which a memory dump and a reboot are performed in parallel according to the embodiment, efficiency in the use of resources may be enhanced.

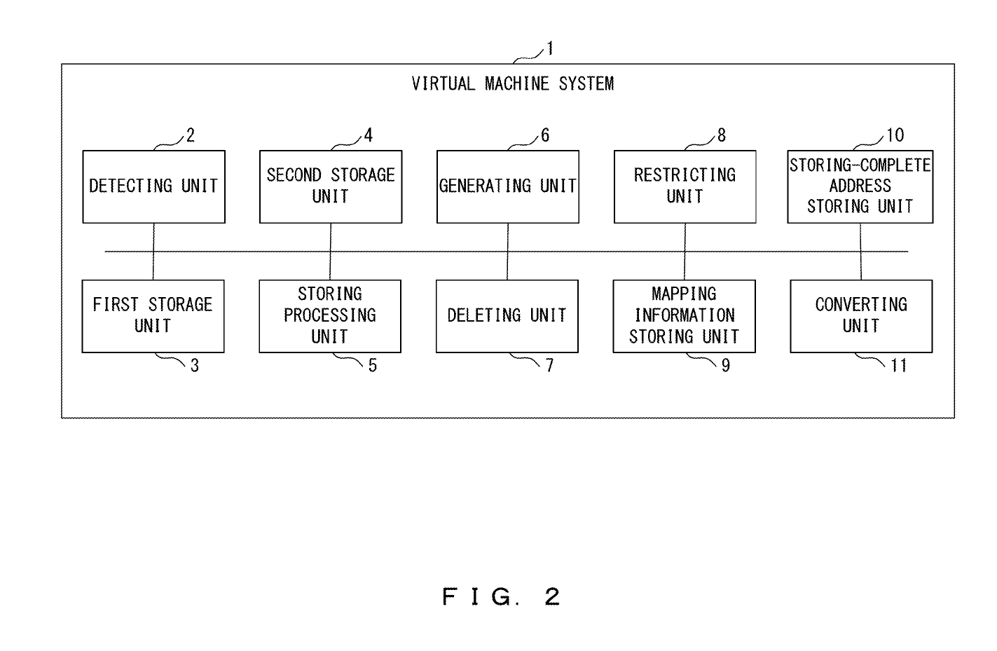

FIG. 2 illustrates an example of a virtual machine system according to the embodiment. A virtual machine system 1 includes a detecting unit 2, a first storage unit 3, a second storage unit 4, a storing processing unit 5, a generating unit 6, a deleting unit 7, a restricting unit 8, a mapping information storing unit 9, a storing-complete address storing unit 10, and a converting unit 11.

The detecting unit 2 detects a failure of a virtual machine. A virtual machine realizes a function of a set of pieces of hardware for programs to operate as software.

The first storage unit 3 is a storage area allocated for a virtual machine to operate.

The second storage unit 4 stores information stored in the first storage unit 3.

The storing processing unit 5 stores information stored in the first storage unit 3 into the second storage unit 4.

The generating unit 6 generates the storing processing unit 5 when a failure of a virtual machine is detected by the detecting unit 2.

The deleting unit 7 deletes the storing processing unit 5 when the storing by the storing processing unit 5 is completed.

The restricting unit 8 restricts the access from a virtual machine to the first storage unit 3 when a failure of the virtual machine is detected by the detecting unit 2. In addition, the restricting unit 8 permits the access from the virtual machine to the first storage unit 3 along with the progress in the storing by the storing processing unit 5.

The mapping information storing unit 9 stores mapping information that is information in which the physical address of a virtual machine and the physical address of a virtual machine system are associated.

The storing-complete address storing unit 10 stores the physical address of a portion in the first storage unit 3 for which the storing by the storing processing unit 5 has completed.

The converting unit 11 converts the physical address of the virtual machine system in the mapping information stored in the mapping information storing unit 9 into an address obtained from the storing-complete address storing unit 10, when an access is made from a virtual machine to the restricted area.

Details of the embodiment are described below.

### First Embodiment

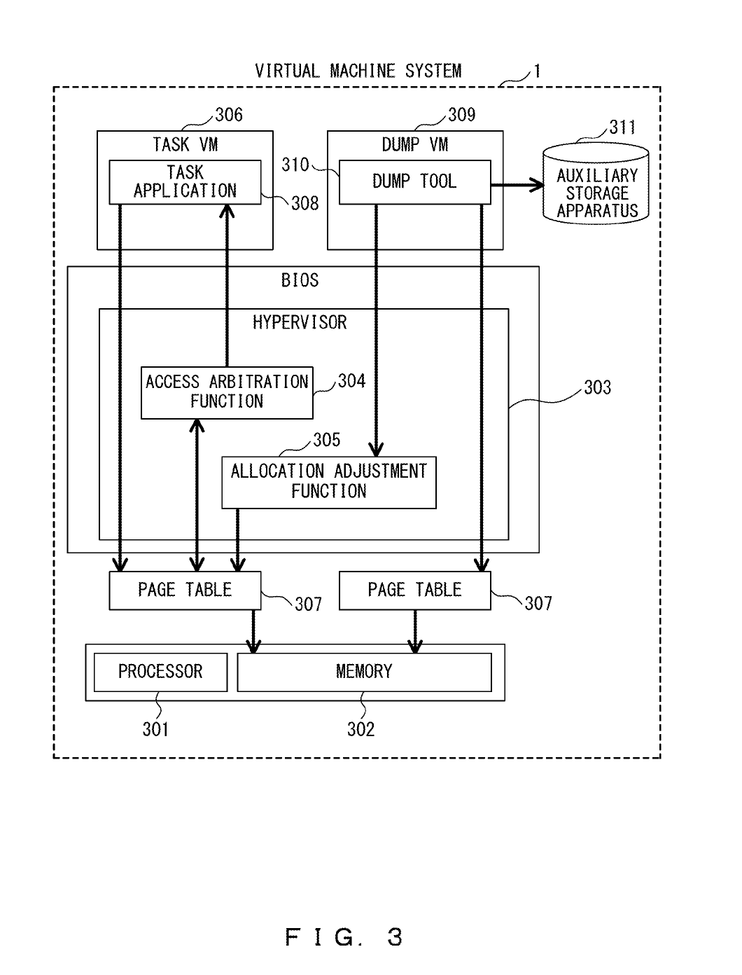

FIG. 3 illustrates an example of the configuration of a virtual machine system according to the first embodiment.

A virtual machine system 1 includes a processor (CPU) 301, a memory 302, a hypervisor 303, an access arbitration function 304, an allocation adjustment function 305, a task VM 306, a page tables 307, a task application 308, a dump VM 309, a dump tool 310, and an auxiliary storage apparatus 311. The memory 302 is an example of the first storage unit 3 in FIG. 2. The hypervisor 303 is an example of the detecting unit 2, the generating unit 6, the deleting unit 7, and the converting unit 11 in FIG. 2. The access arbitration function 304 and the allocation adjustment function 305 are an example of the restricting unit 8 in FIG. 2. The page table 307 is an example of the mapping information storing unit 9 in FIG. 2. The dump VM 309 is an example of the storing processing unit 5 in FIG. 2. The auxiliary storage apparatus 311 is an example of the second storage unit 4 in FIG. 2.

In the virtual machine system 1, a control program called the hypervisor 303 is executed by the processor 301.

The memory 302 is a physical memory of the virtual machine system 1, which is allocated to virtual machines by the hypervisor 303.

The hypervisor 303 operates directly on the hardware, and it makes virtual machines operate.

In the first embodiment, virtual machines that operate on the hypervisor 303 are categorized into two types according to their uses. One is the virtual machine for general purposes, such as for use in the usual task processing and the like. The other is the virtual machine used for the purpose of performing the memory dump.

Hereinafter, the virtual machine for general usage purposes such as to execute a task application is referred to as the task VM 306, and the virtual machine used for the purpose of performing the memory dump is referred to as the dump VM 309, for convenience of explanation. The dump VM 309 may be used exclusively for the purpose of performing the memory dump.

For example, an OS runs on the task VM 306, and the task application 308 is executed on the OS. The OS does not run on the dump VM 309, and the dump VM 309 performs the memory dump using the dump tool 310 that is the dump function of the BIOS. The dump VM 309 accesses the memory of the task VM 306 in which abnormality has occurred, and it stores the content of the memory into the auxiliary storage apparatus 311.

In addition to the virtualization function such as to make virtual machines operate, the hypervisor 303 includes the access arbitration function 304 and the allocation adjustment function 305. The access arbitration function 304 and the allocation adjustment function 305 are functions for performing the dump process by the dump VM 309 in parallel with the initialization of the task VM 306 as well as subsequent processes in the task VM 306. Specifically, the access arbitration function 304 and the allocation adjustment function 305 cooperate with each other to control memory areas allocated to the two VMs, namely the task VM 306 and the dump VM 309. At the start of the process, the entirety of the memory is allocated to the dump VM 309, and then, the areas for which the dump process has been completed are sequentially allocated to the task VM 306. The control of the memory allocation enables parallel processing between the task VM 306 and the dump VM 309, while preventing destruction of the information in the memory at the time of occurrence of a failure.

The access arbitration function 304 prevents the information in the memory at the time of occurrence of the failure from being destroyed by an access from the task VM 306 to a memory area for which the memory dump has not been completed. Specifically, the access arbitration function 304 prevents the destruction of data in the memory by prohibiting the write access from the task VM 306 to a dump-incomplete memory area. Details of this function are described later.

The allocation adjustment function 305 is a function that permits the access from the task VM 306 to the memory area for which the memory dump has been completed, to increase the available memory for the task VM 306. Specifically, the allocation adjustment function 305 increases the available memory for the task VM 306 by changing the setting in the page table 307. Details of this process are described later.

The page table 307 is a table that performs conversion between a guest physical address and a host physical address. The guest physical address is the physical address of a virtual machine. The host physical address is the physical address of a virtual machine system. When a virtual machine accesses the memory 302, it obtains the host physical address using information in the page table 307. The page table 307 is kept in the BIOS.

One page table 307 may be created for each virtual machine, and a process executed by the processor 301 corresponding to the same virtual machine may all refer to the same page table 307. On the other hand, a plurality of processes executed by the processor 301 corresponding to the different virtual machines respectively refer to a different page table 307.

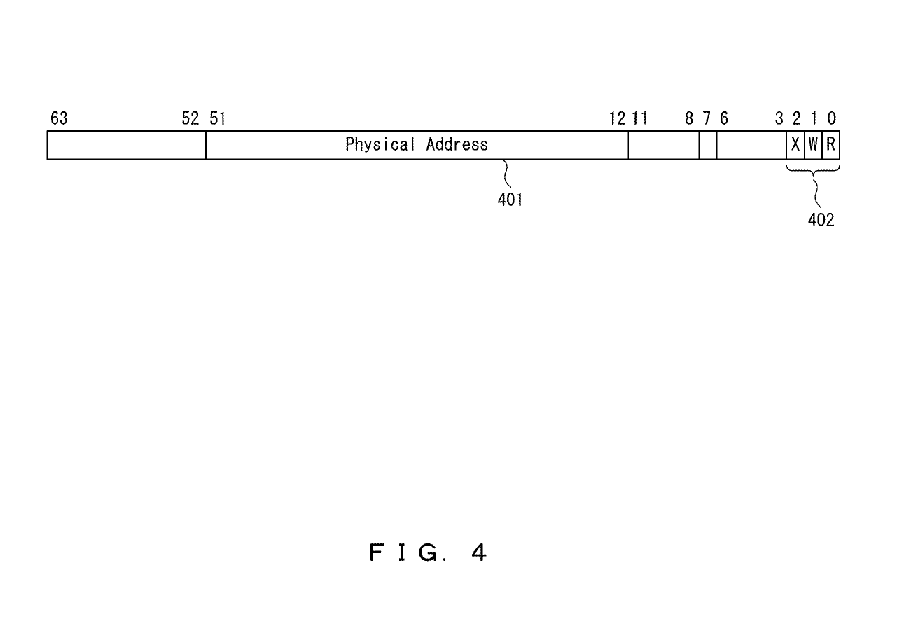

FIG. 4 illustrates an example of the structure of the page table 307. In FIG. 4, “Physical Address” 401 is the host physical address indicated by the entry. In FIG. 4, X, W, R bits (permission bits 402) are permission bits that represent whether or not the access to the address range indicated by the entry is permitted, and they represent that the address range indicated by the entry is “executable”, “writable”, and “readable” areas, respectively. When a memory access from a virtual machine is out of the conversion range in the page table 307, or when the access is prohibited by the permission bits 402, a paging exception occurs, and the CPU shifts the processing to the hypervisor 303. Meanwhile, the page table 307 may be configured so that the conversion of the address is performed using page tables in multiple levels. In this case, the “Physical Address” 401 indicates the address of a lower-level table that is referred to from the entry or a part of the host physical address.

Hereinafter, an example of the process flow in the first embodiment is explained.

Only the task VM 306 operates during the normal operation. When a failure occurs in the task VM 306, the hypervisor 303 starts a process for a memory dump. That is, the hypervisor 303 creates the dump VM 309 immediately after the detection of the failure, and the created dump VM 309 starts dumping memory areas of the task VM 306.

During the memory dump, the two virtual machines, namely the task VM 306 and the dump VM 309 operate in parallel. The task VM 306 performs the initialization process, and the dump VM 309 performs the dump process. Along with the progress in the dump process, the allocation of memory areas between the task VM 306 and the dump VM 309 is changed. At the start of the dump process, all of the memory areas of the task VM 306 are allocated to the dump VM 309. Along with the progress in the dump process, the areas for which the dump has been completed are allocated to the task VM 306, and the memory capacity allocated to the task VM 306 gradually increases. When the dump process is eventually completed for all of the memory areas, all of the memory areas is allocated to the task VM 306. After that, the dump VM 309 is discarded.

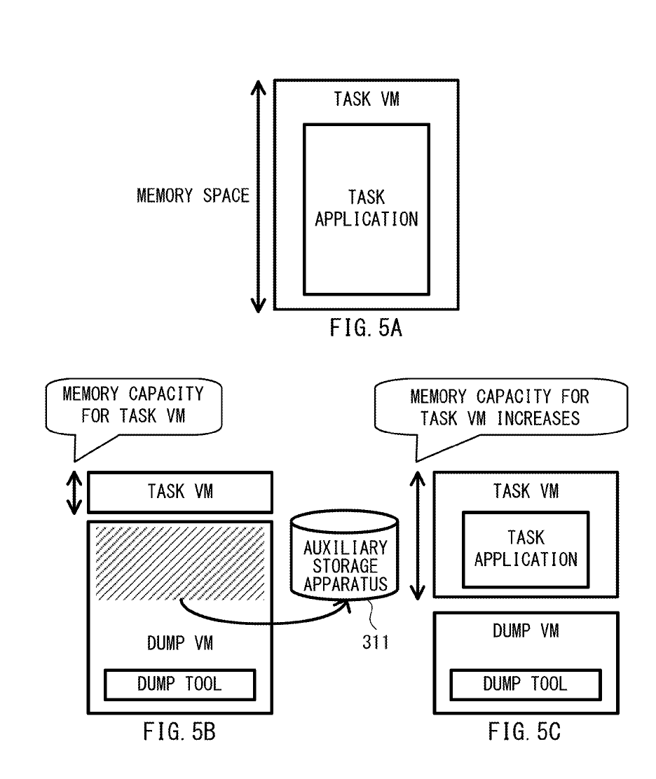

This process is explained in FIG. 5A through FIG. 5C.

FIG. 5A illustrates the memory usage state during the normal operation. The dump VM 309 does not exist during the normal operation as illustrated in FIG. 5A, and the memory of the task VM 306 is allocated only to the task VM 306.

FIG. 5B illustrates the memory usage state during the dump process. Memory areas that were allocated to the task VM 306 during the normal operation are allocated to the dump VM 309, and the dump VM 309 writes the memory areas allocated to the dump VM 309 as a dump file into the auxiliary storage apparatus 311. The memory areas for which the writing into the auxiliary storage apparatus 311 has been completed are allocated to the task VM 306.

The shaded portion in FIG. 5B indicates a target area for one dump. The memory allocation is changed every time the dump for a target area for one dump is completed, and the memory areas for which the dump has been completed are allocated to the task VM 306.

FIG. 5C illustrates the memory usage state after the allocation change. As is understood by comparing FIG. 5B and FIG. 5C, the memory areas used by the task VM 306 increase while the memory areas used by the dump VM 309 decrease, along with the progress in the dump process.

The dump process is repeated as described above, and the dump VM 309 dumps all of the allocated memory areas. After the completion of the dump for all of the memory areas, the hypervisor 303 discards the dump VM 309, and the operation returns to the state of the normal operation in FIG. 5A.

Next, operations in creating the dump VM 309 are explained.

The dump VM 309 is created by the hypervisor 303 immediately after occurrence of a failure in the task VM 306. The setting file used in the creation is stored in a storage unit on the BIOS. The setting file may store, for example, information of the output destination of the dump file, and the amount for one dump.

The dump target area is specified as the dump VM 309 uses a copy of the page table 307 of the task VM 306 as its own page table 307 of the dump VM 309. That is, when creating the dump VM 309, the hypervisor 303 copies the page table 307 of the task VM 306 and sets it as the page table 307 to be used by the dump VM 309.

The memory area used by the dump VM 309 itself are secured separately from the memory area for the task VM 306 in advance. The memory areas used by the dump VM 309 itself only need a capacity that is sufficient for controlling the copy of the page table 307 of the task VM 306 on the memory. This is because the dump VM 309 does not start the OS, and the dump process is performed using the function on the BIOS. With such a configuration, it becomes possible to perform the dump process with minimum additional resources.

Next, how to control the memory allocation for the task VM 306 and the dump VM 309 is explained.

The page tables 307 of the task VM 306 and the dump VM 309 are used for controlling the memory allocation for the task VM 306 and the dump VM 309.

The control of the memory allocation is realized, specifically, by the access arbitration function 304 and the allocation adjustment function 305 by changing the setting of the permission bits 402 in the page table 307 of the task VM 306.

Immediately after occurrence of a failure in the task VM 306, the access arbitration function 304 sets the permission bits 402 for all of the memory areas in the page table 307 to be unwritable. After that, for the memory areas for which the dump has been completed, the allocation adjustment function 305 sequentially changes the values of the permission bits 402 to be writable, thereby permitting the access from the task VM 306 to the memory for which the dump has been completed.

When an access that is not permitted by the permission bits 402 of the page table 307 is made, a paging exception occurs, and the processing (the operation mode) in the processor 301 shifts from the task VM 306 to the hypervisor 303.

In addition, the access from the dump VM 309 to the memory areas for which the dump has been completed may be prohibited. In this case, the permission bits 402 in the page table 307 of the dump VM 309 may be set to be inaccessible.

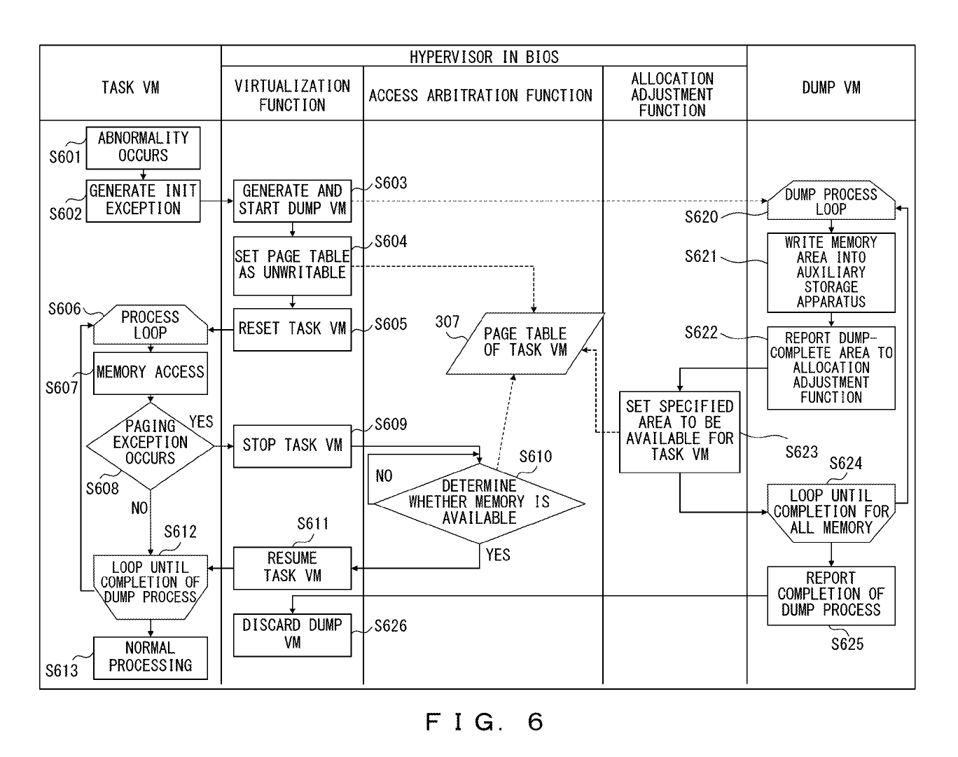

Next, details of the flow of the processing in the first embodiment are explained using the flowchart in FIG. 6.

As illustrated in FIG. 6, the virtual machine system 1 according to the first embodiment includes the task VM 306, the dump VM 309, the virtualization function of the hypervisor 303, the access arbitration function 304, and the allocation adjustment function 305. The flowchart explains occurrence of abnormality through resumption of the operation.

When abnormality occurs in the task VM 306 (S601), the OS being executed in the task VM 306 generates an exception for a dump process, and it throws the exception into the hypervisor 303 (S602).

Upon catching the exception thrown from the task VM 306 and detecting the abnormality, the hypervisor 303 generates the dump VM 309 and starts the dump VM 309 (S603). The dump VM 309 is created by the hypervisor 303 by reading the setting file stored in the BIOS. When creating the dump VM 309, the hypervisor 303 allocates all of the memory areas of the task VM 306 to the dump VM 309. That is, the hypervisor 303 creates the page table 307 of the dump VM 309 by copying the page table 307 of the task VM 306. In addition, when starting the dump VM 309, the hypervisor 303 makes the dump VM 309 perform the dump process by transmitting an exception for the dump process to the dump VM 309.

Next, the hypervisor 303 prohibits the write access from the task VM 306 to the entirety of the memory areas (S604). That is, the hypervisor 303 sets the values of the permission bits 402 for all addresses in the page table 307 of the task VM 306 to be unwritable. Accordingly, a paging exception occurs when the task VM 306 makes a write access to any address. Here, the read access does not have to be prohibited. In addition, the prohibition of the write access may be set for given memory areas to be the target of protection.

Next, the hypervisor 303 resets and restarts the task VM 306 (S605). The dump VM 309 and the task VM 306 start the parallel operations at this stage.

The processes of S620 through S626 are related to the operations of the dump VM 309 from the start of the dump through the completion of the dump.

The dump VM 309 starts the memory dump using the dump tool 310 that is realized with a function of the BIOS (S620). At this time, the dump VM. 309 writes the content of the memory of the task VM 306 into the auxiliary storage apparatus 311 specified as the output destination (S621). Upon completion of the dump for an amount of memory to be dumped by one dump which is set in advance, the process moves to S622. The output destination and the amount of memory to be dumped by one dump used in S620 and S621 are described in the setting file that the hypervisor 303 reads when it creates the dump VM 309 (S603).

S622 and S623 are related to the operations to make the memory areas which have been written into the auxiliary storage apparatus 311 available for use by the task VM 306 as dump-complete areas.

The dump VM 309 reports the areas for which the dump has been completed to the allocation adjustment function 305 (S622).

Next, the allocation adjustment function 305 makes a setting in the page table 307 of the task VM 306 for the dump-complete areas reported in S622 to be accessible from the task VM 306 (S623). Specifically, the allocation adjustment function 305 changes the values of the permission bits 402 of the page table 307 from unwritable to writable. Accordingly, the memory becomes writable without occurrence of a paging exception when the task VM 306 makes a memory access. At this time, in order to prohibit the access from the dump VM 309 to the dump-complete areas, the allocation adjustment function 305 may set the permission bits 402 of the page table 307 of the dump VM 309 to be inaccessible.

Next, the dump VM 309 determines whether or not the dump for all the memory areas has been completed (S624). When it is determined that it has been completed, the loop process of S620 through S624 is terminated, and the process moves to S625. When it is determined that it has not been completed, the process returns to S620.

In S625, the dump VM 309 reports the completion of the dump process to the hypervisor 303. Upon receiving the report, the hypervisor 303 discards the dump VM 309 (S626).

S606 through S613 are related to the operations of the task VM 306 from the start of the dump VM 309 to the completion of the dump process.

Together with the start of the processing in the dump VM 309, the initialization process by the BIOS and the OS or the like is started in the task VM 306 (S606 through S612). At the start of the initialization process, no memory is allocated to the task VM 306, and at this stage, the initialization process is started only with the cache memory of the CPU, without using the memory. After that, along with the progress in the initialization process, the task VM 306 starts making an access to the memory.

When the task VM 306 makes a memory access (S607), an exception occurs in a case in which the access is a write access to a dump-incomplete area (S608). When making a memory access, the task VM 306 always refers to its own page table 307, to determine which host physical address it is going to access. At this time, the task VM 306 checks the permission bits 402 for the address of the access destination, and when the operation is not permitted, it generates an exception. According to the setting made in S604, the permission bits 402 for the dump-incomplete areas are set to be unwritable, and therefore, a write access to these areas cause a paging exception.

The exception occurred in S608 is caught by the hypervisor 303, and the hypervisor 303 stops the task VM 306 (S609).

Next, the hypervisor 303 monitors the page table 307 of the task VM 306 and waits until the memory area accessed in S607 becomes available (S610). That is, the access arbitration function 304 polls the page table 307, to keep monitoring until the target memory area becomes accessible. After that, when the page table 307 of the task VM 306 is updated by the allocation adjustment function 305 to permit the access (S623), the process moves to S611.

In S611, the hypervisor 303 resumes the task VM 306. The task VM 306 resumes processing from the point of time at which the processing was suspended in S608.

Next, when the dump for all of the memory areas has been completed in S612, the process moves to the normal task state (S613). When there is any dump-incomplete area, the process returns to S606.

The first embodiment is as described above. Meanwhile, regarding the access to be restricted, a read access or an execution access may also be restricted, in addition to the write access.

### Second Embodiment

In the first embodiment, there is a possibility that the processing in the task VM 306 remains suspended for along time because the memory dump for an address accessed by the task VM 306 has not been completed, although there are other memory areas for which the dump has been completed. As a method to prevent this, a method in which an unused area pool is used when changing the memory allocation for the task VM 306 and the dump VM 309 is explained.

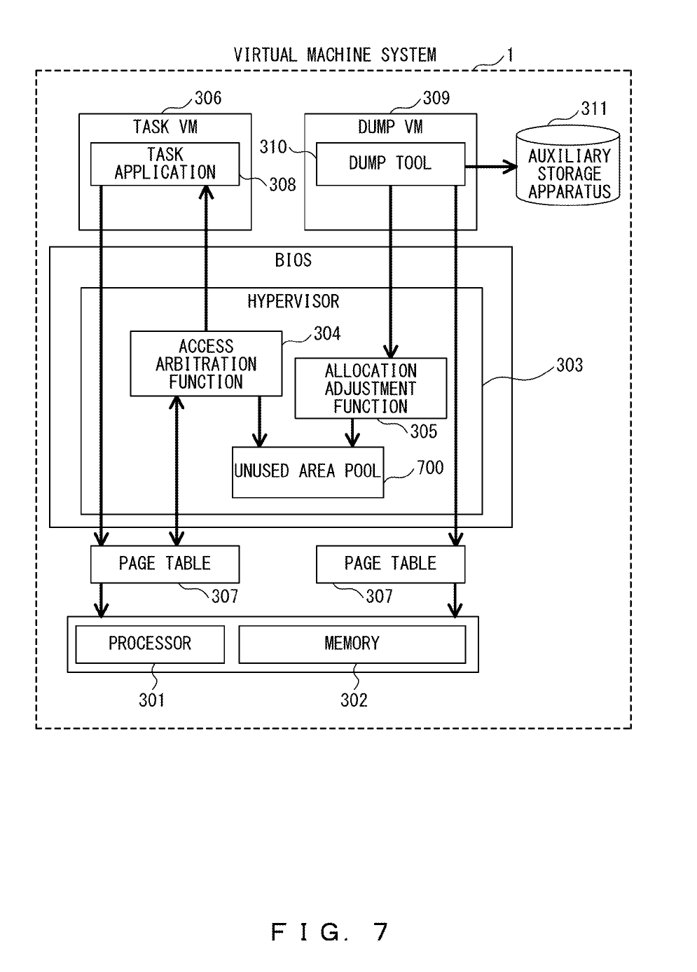

FIG. 7 is a configuration diagram for the second embodiment. In FIG. 7, an unused area pool 700 is added to FIG. 3. The unused area pool 700 is provided for performing unitary management of the dump-complete memory areas. The unused area pool 700 is an example of the storing-complete address storing unit 10 in FIG. 2. As illustrated in FIG. 7, the unused area pool 700 is kept on the BIOS.

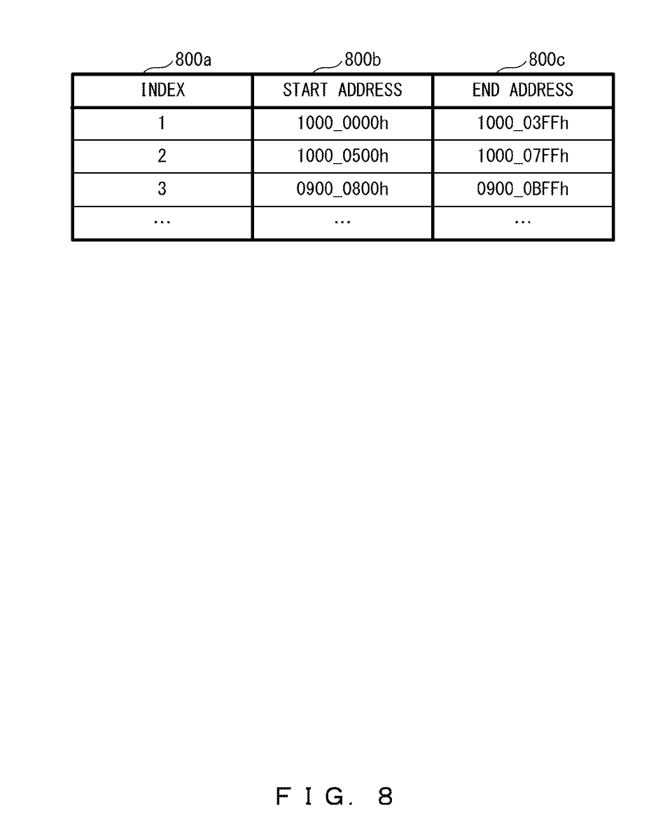

FIG. 8 illustrates the table structure of the unused area pool 700. The unused area pool 700 includes fields for an “INDEX” 800a, a “START ADDRESS” 800b, and an “END ADDRESS” 800c. The “START ADDRESS” 800b stores the start address of an unused area. The “END ADDRESS” 800c stores the end address of the unused area.

The hypervisor 303 registers information about the memory areas for which the dump has been completed to the unused area pool 700, as the unused area. Then, when a paging exception occurs, the hypervisor 303 allocates the pooled memory to the task VM 306 as available memory. Specifically, the hypervisor 303 changes the host physical address associated with the virtual physical address accessed by the task VM 306 to the host physical address of the pooled memory. In a case in which there is no pooled memory when a paging exception occurs, the task VM 306 is stopped in the same manner as the manner in the first embodiment, to wait until a dump-complete area appears.

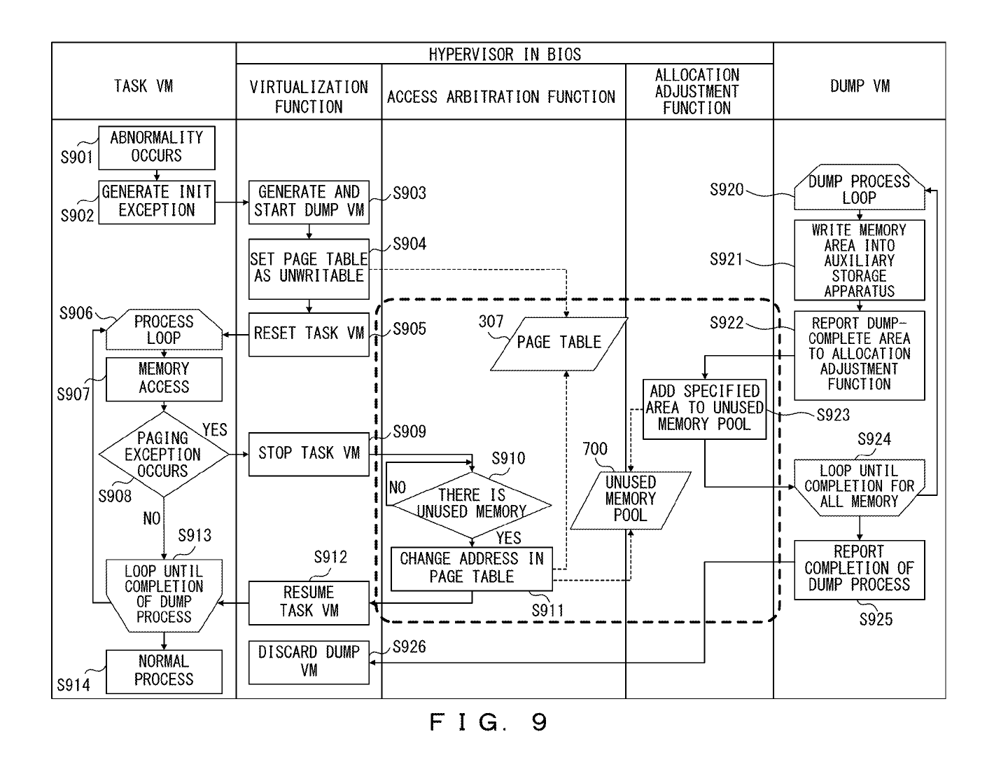

FIG. 9 is a flowchart of the processing in the embodiment. FIG. 9 differs from FIG. 6 in the portion enclosed with a dotted line.

After the task VM 306 is stopped (S909), the access arbitration function 304 refers to the unused area pool 700 to determine whether or not there is any unused area in the memory (S910). Specifically, the access arbitration function 304 determines whether or not there is any unused area according to whether or not there is any entry in the unused area pool 700. When there is no unused area, the access arbitration function 304 polls and monitors the unused area pool 700 until an unused area is registered in the unused area pool 700 by the allocation adjustment function 305 (S923). When there is an unused area, the process moves to S911.

Meanwhile, when a dump-complete area is reported from the dump VM 309 (S922), the allocation adjustment function 305 registers the dump-complete area in the unused area pool 700 (S923). Specifically, the start address and the end address of the dump-complete area are registered in the start address 800b and the end address field 800c of the unused area pool 700, respectively.

In S911, when it is determined that there is an unused area, the access arbitration function 304 obtains the unused area from the unused area pool 700. Then, the access arbitration function 304 changes the host physical address in the page table 307 of the task VM 306 associated with the virtual physical address accessed in S907 to the address of the obtained unused area (S911). In addition, in order to permit the access to the obtained unused area, the access arbitration function 304 sets the permission bits 402 in the page table 307 for the obtained unused area to be writable. The access arbitration function 304 further deletes the used area from the unused area pool 700. As the specific operation to delete the used area from the unused area, for example, the entry in the unused area pool 700 may be deleted or divided, or the value of the start or the end address field may be changed.

In addition, for example, for the unused area address to be obtained from the unused area pool 700, an order may be set, such as to obtain the unused area address from the unused area pool 700 from the start address of the entry in the unused area pool 700. After that, the process moves to S912, and the processing in the task VM 306 is resumed.

In the second embodiment, the task VM 306 does not stop as long as there is a pooled memory. Therefore, the time during which the task VM 306 is suspended to wait for the dump is reduced, improving the performance of the task VM 306.

### Third Embodiment

Next, as a method to change the memory allocation, a method in which a hot-add function is used to recognize an additional device without stopping the virtual machine is explained.

This method is based on conditions that the OS boot has been completed in the task VM 306 and the OS running on the task VM 306 supports the memory hot-add function. Before the OS boot is performed, the memory allocation is controlled in the method in the first embodiment or the second embodiment.

In the first and the second embodiments, the memory allocation for the task VM 306 and the dump VM 309 is controlled by the access arbitration function 304 and the allocation adjustment function 305 of the hypervisor 303. In contrast, after the OS is started in the third embodiment, the memory allocation is controlled using the memory hot-add function. Specifically, when starting the OS in the task VM 306, the hypervisor 303 makes a setting so that the OS is unable to recognize the dump-incomplete area as a device, and it sequentially lets the OS make additional recognition of the memory areas for which the dump has been completed, using the memory hot-add function. Accordingly, the OS of the task VM 306 recognizes only the memory areas for which the dump has been completed. Therefore, no access is to be made to the dump-incomplete area, and no paging exception occurs due to an access from the task VM 306 to a dump-incomplete area. Accordingly, no operation stop is caused by the access arbitration function 304.

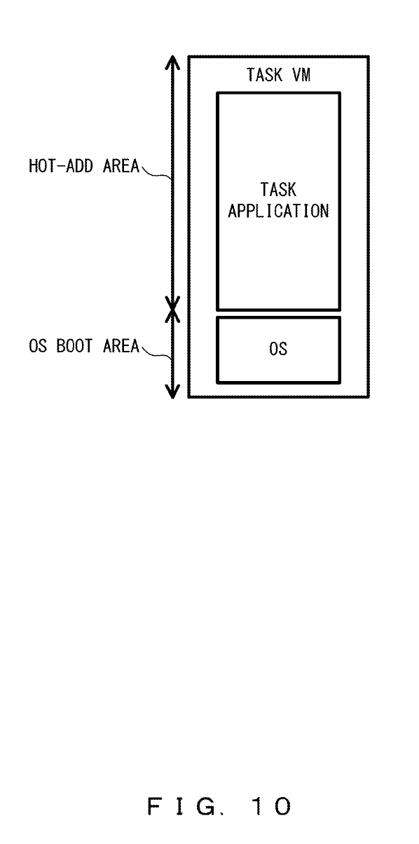

In this method, the address space of the task VM 306 is divided into the OS boot area and the hot-add areas, as illustrated in FIG. 10.

When starting the OS, the task VM 306 reports to the OS the capacity of the memory to be used by the OS, and the OS recognizes the memory corresponding to the reported capacity. In the third embodiment, the reported capacity of the memory is the size of the OS boot area. The size of the OS boot area has a capacity that is sufficient for booting the OS, and the OS boots in this area. The reporting of the memory capacity may be done using a technique such as the function of the BIOS or the ACPI (Advanced Configuration and Power Interface) function. The ACPI function is a function for the OS to cooperate with the BIOS to manage the power for respective parts inside a computer.

The memory in the hot-add area is not recognized by the OS immediately after the OS is started, and it is sequentially recognized by the OS along with the progress in the completion of the dump.

The task application 308 mainly operates on the memory in the hot-add area.

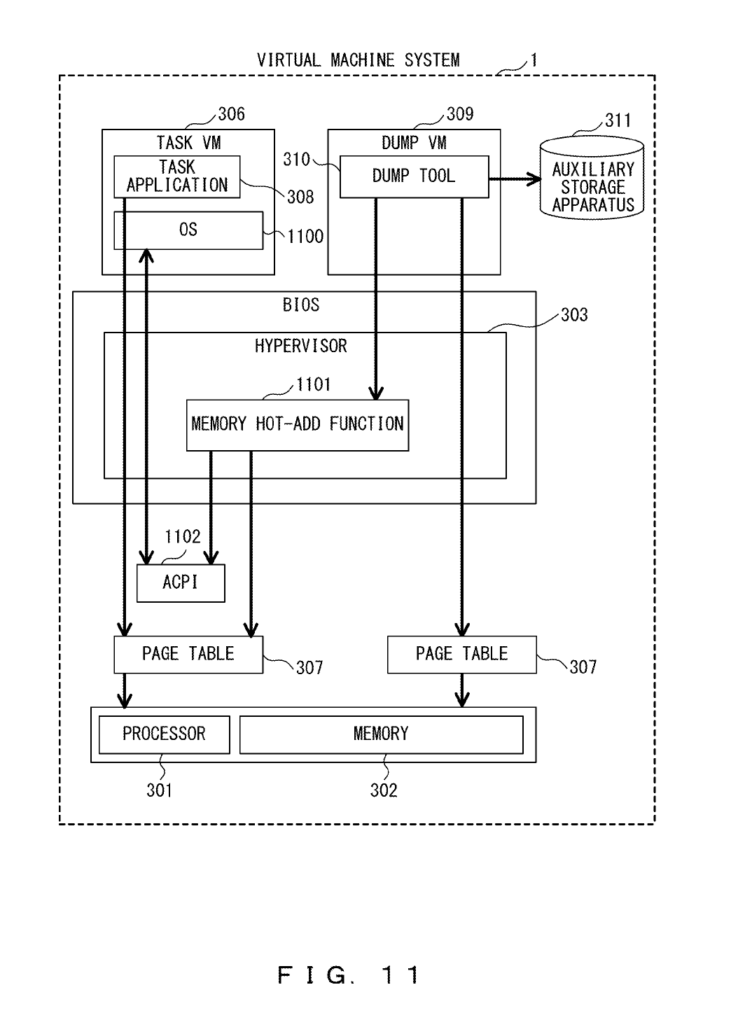

FIG. 11 illustrates an example of the configuration after the OS is started in the task VM 306 in the third embodiment. Compared with FIG. 3, an OS 1100 is added in the task VM 306 in FIG. 11. The virtual machine system 1 according to the third embodiment supports an ACPI function 1102. In addition, the hypervisor 303 after the start of the OS 1100 in the third embodiment includes a memory hot-add function 1101 instead of the access arbitration function 304 and the allocation adjustment function 305.

The method in the third embodiment differs from the method in the first embodiment or the second embodiment in the operations after the OS boot. Before the OS boot, the task VM 306 and the dump VM 309 operate according to the method in the first embodiment or the second embodiment to adjust the memory in the OS boot area. After the OS boot, the hypervisor 303 adjusts the memory using the hot-add function instead of using the access arbitration function 304 and the memory adjustment function 305. The operations after the OS boot are explained below.

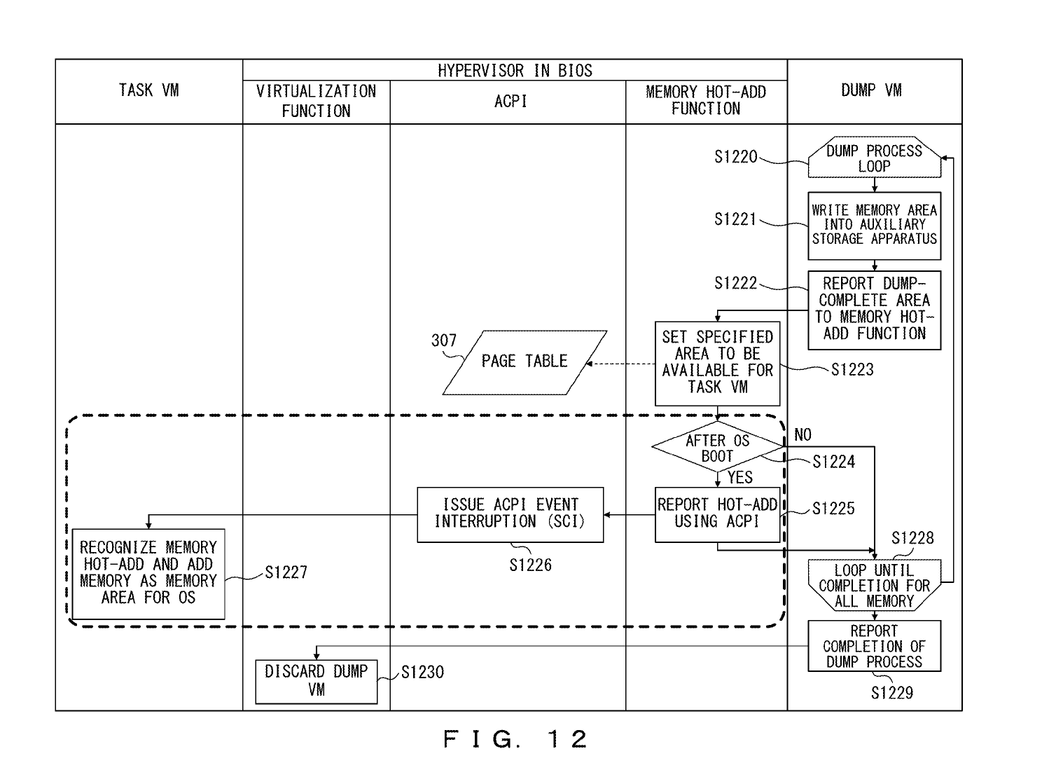

FIG. 12 is a flowchart for the third embodiment. Compared with FIG. 6, there is an addition of the processes in the portion enclosed with a dotted line.

In S1224, the hypervisor 303 determines whether or not the boot of OS 1100 has been completed. Specifically, the hypervisor 303 determines whether or not the boot of OS 1100 has been completed according to whether or not the initialization of the ACPI function 1102 has been completed. That is, when the initialization has been completed, it is determined that the boot of the OS 1100 has been completed. When it is determined that the boot has been completed, the process moves to S1225. When the boot has not been completed, the process moves to S1228, and processes similar to those in the first embodiment or the second embodiment are continued.

Upon receiving a hot-add report from S1225, the ACPI issues an event interruption (SCI) (S1226). This interruption is caught by the OS 1100 of the task VM 306, and the OS 1100 recognizes the memory areas for which the dump has been completed as the memory areas to be used by the OS 1100 itself (S1227). As a result, the memory areas available for the OS 1100 increase.

Meanwhile, the embodiment is not limited to the embodiments described above and may take various configurations or embodiments without departing from the gist of the embodiment. While the subject that performs the dump process is defined as a virtual machine, it is not limited to a virtual machine.

All examples and conditional language provided herein are intended for the pedagogical purposes of aiding the reader in understanding the invention and the concepts contributed by the inventor to further the art, and are to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A virtual machine system comprising:
a first storage unit configured to include a storage area allocated for a first virtual machine to operate;
a second storage unit configured to store information stored in the first storage unit; and
a processor that executes a process including:
detecting a failure of a first virtual machine;
generating a second virtual machine when a failure of the first virtual machine is detected and making the second virtual machine perform storing information stored in the first storage unit into the second storage unit; and
deleting the second virtual machine when the storing by the second virtual machine is completed.

2. The virtual machine system according to claim 1, the process further including:
restricting an access from the first virtual machine to the first storage unit, when a failure of the first virtual machine is detected.

3. The virtual machine system according to claim 2, the process further including:
permitting the access from the first virtual machine to the first storage unit, along with a progress in the storing by the second virtual machine.

4. The virtual machine system according to claim 3, the virtual machine system further comprising:
a mapping information storing unit configured to store mapping information that is information in which a physical address of the first virtual machine and a physical address of the virtual machine system are associated; and
a storing-complete address storing unit configured to store a storing-complete address that is a physical address of a portion for which the storing by the second virtual machine has been completed in the storage area of the first storage unit, wherein
the process further including:
obtaining the storing-complete address from the storing-complete address storing unit when an access is made from the first virtual machine to the storage area to which an access is restricted, and to convert, into the obtained storing-complete address, a physical address of the first virtual machine system associated with a physical address of the first virtual machine to which the access has been made, in the mapping information stored in the mapping information storing unit.

5. The virtual machine system according to claim 2, wherein
the first virtual machine includes a recognizing function to recognize a device without stopping the first virtual machine, and
the permitting permits the access from the first virtual machine to the first storage unit by making the first virtual machine recognize a portion for which the storing by the second virtual machine has been completed in the storage area of the first storage unit using the recognizing function, along with a progress in the storing by the second virtual machine.

6. A non-transitory computer-readable recording medium having stored therein a program for causing a computer to execute a process, the process comprising:
detecting a failure of a first virtual machine;
generating, when a failure of the first virtual machine is detected, a second virtual machine and making the second virtual machine perform storing information stored in a first storage unit configured to include a storage area allocated for the first virtual machine to operate into a second storage unit configured to store information stored in the first storage unit; and
deleting the second virtual machine when the storing by the second virtual machine is completed.

7. The non-transitory computer-readable recording medium according to claim 6, the process further comprising:
restricting an access from the first virtual machine to the first storage unit, when a failure of the first virtual machine is detected.

8. The non-transitory computer-readable recording medium according to claim 7, the process further comprising:
permitting the access from the first virtual machine to the first storage unit, along with a progress in the storing by the second virtual machine.

9. The non-transitory computer-readable recording medium according to claim 8, the process further comprising:
storing, in a storing-complete address storing unit, a storing-complete address that is a physical address of that is a physical address of a portion for which the storing by the second virtual machine has been completed in the storage area of the first storage unit; and
obtaining the storing-complete address from the storing-complete address storing unit when an access is made from the first virtual machine to the storage area to which an access is restricted, and converting, into the obtained storing-complete address, a physical address of the virtual machine system associated with a physical address of the first virtual machine to which the access has been made, in information in which a physical address of the first virtual machine and a physical address of the virtual machine system are associated.

10. The non-transitory computer-readable recording medium according to claim 8, wherein
the permitting permits the access from the first virtual machine to the first storage unit by making the first virtual machine recognize a portion for which the storing by the second virtual machine has been completed in the storage area of the first storage unit using a recognizing function to recognize a device without stopping the first virtual machine, along with a progress in the storing by the second virtual machine.

11. An information storing processing method comprising:
detecting a failure of a first virtual machine;
generating, when a failure of the first virtual machine is detected, a second virtual machine and making the second virtual machine perform storing information stored in a first storage unit configured to include a storage area allocated for the first virtual machine to operate into a second storage unit configured to store information stored in the first storage unit; and
deleting the second virtual machine when the storing by the second virtual machine is completed.

12. The information storing processing method according to claim 11, the information storing processing method further comprising:
restricting an access from the first virtual machine to the first storage unit, when a failure of the first virtual machine is detected.

13. The information storing processing method according to claim 12, the information storing processing method further comprising:
permitting the access from the first virtual machine to the first storage unit, along with a progress in the storing by the second virtual machine.

14. The information storing processing method according to claim 13, the information storing processing method further comprising:
storing, in a storing-complete address storing unit, a storing-complete address that is a physical address of that is a physical address of a portion for which the storing by the second virtual machine has been completed in the storage area of the first storage unit; and
obtaining the storing-complete address from the storing-complete address storing unit when an access is made from the first virtual machine to the storage area to which an access is restricted, and converting, into the obtained storing-complete address, a physical address of the virtual machine system associated with a physical address of the first virtual machine to which the access has been made, in information in which a physical address of the first virtual machine and a physical address of the virtual machine system are associated.

15. The information storing processing method according to claim 12, wherein
the permitting permits the access from the first virtual machine to the first storage unit by making the first virtual machine recognize a portion for which the storing by the second virtual machine has been completed in the storage area of the first storage unit using a recognizing function to recognize a device without stopping the first virtual machine, along with a progress in the storing by the second virtual machine.
